(19) United States
(12) Patent Application Publication
(10) Pub. No.: US 2003/0183089 A1
(43) Pub. Date: Oct. 2, 2003

(54) One-piece round, size-adjustable pie weight

(76) Inventors: David Glen Blackburn, Long Beach, CA (US); Araceli Robles-Lopez Epousa Salamanca, Sendets (FR)

Correspondence Address: KNOBBE MARTENS OLSON & BEAR LLP, 2040 MAIN STREET, FOURTEENTH FLOOR, IRVINE, CA, 92614, US

(21) Appl. No.: 10/107,953

(22) Filed: Mar. 28, 2002

(51) Int. Cl. A23P 1/00; A47J 43/18

(52) U.S. Cl. 99/432

(57) ABSTRACT

An adjustable one-piece round pie weight used to bake unfilled crusts in a pan or dish or to bake unfilled free-form crusts.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The invention is generally related to baking devices and particularly any device that is used to weight an unfilled pie or tart crust during baking.

Related U.S. patent Classification Definitions are 99/432 Mold for forming sheet material, e.g., pie crust and 99/433 Including pie rim clamp or guard.

The one-piece round, size-adjustable pie weight is an alternative to multiple piece pie weights rice or beans or a pie chain which are typically placed inside a pie or tart crust during its initial phase of baking. Baking a crust with its ultimate filling is disadvantageous because the crust may absorb the liquid from the filling, making the crust mushy or leathery dependent on the filling. In order to have a crispy crust the preferred procedure is to bake the crust unfilled and to then to add the filling later.

One can purchase or make any of several types of dough and form the dough into a flat, free-form shape tart with the edges rolled up or crimped (similar to the shape of a pizza crust) or one can place the dough into a pie pan or dish or one can purchase the dough pre-formed in a disposable pie tin. The dough is baked into a crust into which one can place a topping or filling which may or may not require subsequent baking.

It is necessary to use pie weights to keep the dough flat during the initial crust baking phase to prevent air bubbles underneath and inside the bottom of the crust. The present technology uses flat metal or ceramic spherical pie weights which can be used indefinitely and are ideal conductors of heat during this baking phase as they do not contribute to over-browning the crust. Both are cumbersome to use, wash and to store because one crust may require more than one hundred (100) of these weights. A less cumbersome alternative is to weight the dough with rice or beans which are disposed of after the initial baking phase and essentially wasted. A disadvantage to weighting with rice or beans is that they may bake into the crust making it necessary to wipe them out of the baked crust with a towel in order to dislodge them or to even pick them out individually with a fork or knife. A resolution to this problem is to line the crust with parchment or waxed paper before weighting it with beans or rice. A still yet less cumbersome alternative is a pie chain which is a beaded, 6 foot long stainless steel chain that resembles a long necklace. One would coil this chain into the dough and not necessarily get full coverage of the dough still making it possible to have bubbles. This coiling method is the most complicated means of weighting the dough but it is a good alternative to the ceramic spherical weights for ease of cleaning and storage.

### BRIEF SUMMARY OF THE INVENTION

The invention is a one-piece, round, size-adjustable pie weight. The pie weight encases spherical, balls (preferably ceramic) with a netting that may be made from any flexible, sterile material that will not conduct heat in a manner that burns the crust. Glass thread or extruded aluminum thread are preferred.

The most evident advantage of this invention is that it is only one piece. This one-piece pie weight greatly simplifies storage, handling and washing. To store the pie weight, one can simply place it in a drawer. To use the pie weight, one places it on oven-ready dough and flattens it by gently pressing with the palm of the hand which arranges the balls to conform to the desired form and/or size of the pie pan or dish. To wash the pie weight one can place it in a dishwasher or one may wash it by hand. In addition, the flexible nature of the netted encasement permits one to purchase a single sized pie weight for use with a variety of different sized pans or dishes, i.e.; a twenty-eight centimeter (28 cm) pie weight contracts and conforms to the shape of a twenty-two centimeter (22 cm) pie crust with the excess encased balls naturally settling into a second tier non-functional level.

The netted material may also serve as its own packaging container which provides obvious cost and environmental ramifications for the manufacturer.

### BRIEF DESCRIPTION OF THE SEVERAL VIEWS OF THE DRAWING

FIG. 1a depicts the One-Piece Round, Size-Adjustable Pie Weight inserted into a pie crust.

FIG. 1b depicts the One-Piece Round, Size-Adjustable Pie Weight laying flat.

FIGS. 2a and b depict the One-Piece Round, Size-Adjustable Pie Weight as it is being inserting into a pie crust and they illustrate the flexibility of the netted material.

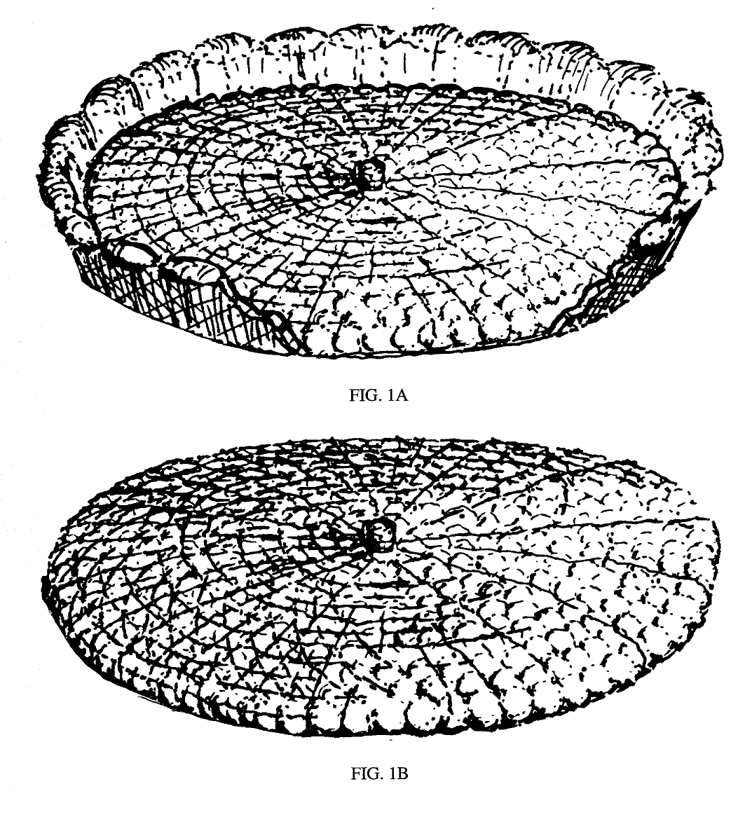

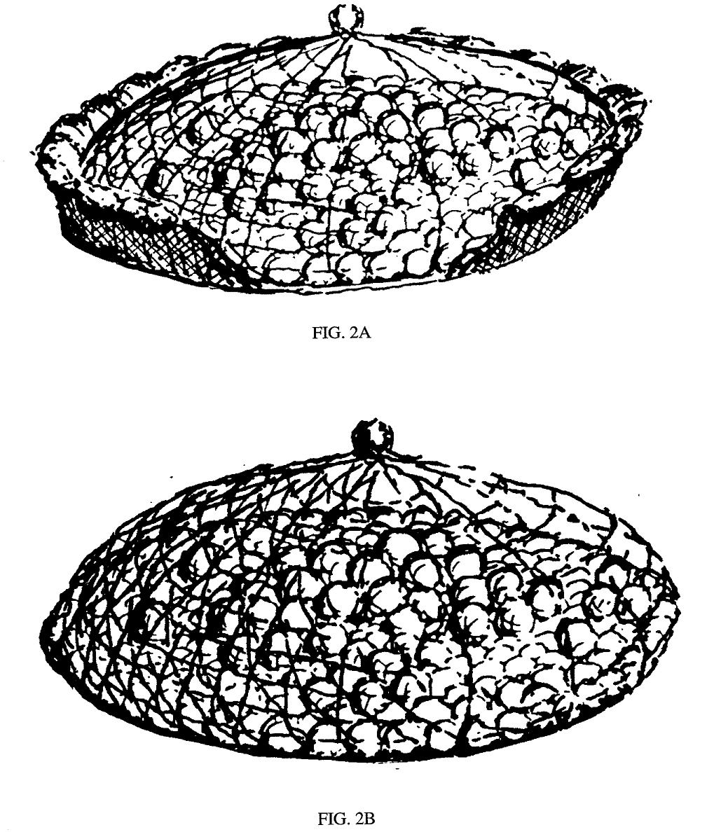

### DETAILED DESCRIPTION OF THE INVENTION

The invention is a one-piece, size-adjustable pie weight. The invention encases spherical balls (preferably ceramic which are an old style of pie weight) in a netting that may be made from any flexible, sterile material that will not conduct heat in a manner that burns the crust. Glass thread or extruded aluminum thread are preferred. The netting may be manufactured in a tubular, sock-like shape the diameter of which will vary based on the finished pie-weight. This sock is then cut into varying lengths, also dimensioned based on the finished pie weight. One end of this netted sock is gathered and sewn closed with a thread which could be identical to the netting material, filled with spherical balls (preferably ceramic), the number of which will correspond to the finished size, then the remaining open end is gathered and sewn closed. This end may be threaded through a loop or a bead with a hole in it to gather the netted material when adjusting for a smaller sized pie pan or dish. Another option is to use flat netted material which may be cut and sewn to achieve the same effect. The openings in the netting should be sized so as to not permit the balls to pass through.

The most evident advantage of this invention is that it is only one piece. This one-piece pie weight greatly simplifies storage, handling and washing. To store the pie weight, one can simply place it in a drawer. To use the pie weight, one places it on oven-ready dough and flattens it by gently pressing with the palm of the hand which arranges the balls to conform to the desired form and/or size of the pie pan or dish. To wash the pie weight one can place it in a dishwasher or one may wash it by hand. In addition, the flexible nature of the netted encasement permits one to purchase a single sized pie weight for use with a variety of different sized pans or dishes, i.e. a twenty-eight centimeter (28 cm) pie weight contracts and conforms to the shape of a twenty-two centimeter (22 cm) pie crust with the excess encased balls naturally settling into a second tier non-functional level. All of these advantages overcome the cumbersome spherical pie weights.

A common alternative to using old pie weights is to use rice or beans. They are easy to use as one can simply pour them into the prepared dough from their box, bag or storage container then after baking the crust one can simply pour them out of the crust and into the trash. A disadvantage to weighting with rice or beans is that they may bake into the crust making it necessary to wipe them out with a towel in order to dislodge them from the crust. A resolution to this problem is to line the crust with parchment or waxed paper before weighting it with beans or rice. This is wasteful and over time more costly than pie weights. The invention overcomes these objections.

Another one-piece alternative is a pie chain. This device requires coiling which is the most cumbersome method of filling the dough and will not necessarily provide full coverage of the dough and permit some bubbles to form in the crust.

The netted material may also serve as its own packaging container which provides obvious cost and environmental ramifications for the manufacturer.

1: We claim a one-piece, round pie weight.

2: We claim a one-piece adjustable pie weight that easily conforms to various forms and sizes of pie pans or dishes.

3: We claim a one-piece pie weight which will conduct and maintain the proper amount of heat to not contribute to unnecessary scorching of the crust.

4: We claim a one-piece pie round weight that can be washed intact.

5: We claim a one-piece pie round weight that also serves as its own packaging container.
